(19) United States
(12) Patent Application Publication
(10) Pub. No.: US 2015/0351009 A1
(43) Pub. Date: Dec. 3, 2015

(54) SYSTEMS AND METHODS FOR SEARCHING FOR A PUBLIC LAND MOBILE NETWORK (PLMN)

(71) Applicant: QUALCOMM Incorporated, San Diego, CA (US)

(72) Inventors: Harinath Reddy Patel, Hyderabad (IN); Mungal Singh Dhanda, Slough (GB); Mahender Reddy Akkapally, Hyderabad (IN); Preethi Ayleni, Hyderabad (IN)

(73) Assignee: QUALCOMM Incorporated, San Diego, CA (US)

(21) Appl. No.: 14/289,377

(22) Filed: May 28, 2014

(51) Int. Cl. H04W 48/16; H04W 84/04; H04W 36/00

(52) U.S. Cl. CPC H04W 48/16; H04W 36/0083; H04W 84/042

(57) ABSTRACT

Embodiments of the present invention include devices, systems and methods for efficient PLMN searching. One method can include initiating a service search procedure. A list of channels to perform a power scan on is prepared. One or more channels are removed from the list of channels that use a same public land mobile network as a camped on cell. Frequencies of the channels are obtained from system information. A power scan is performed on the channels in the list of channels to obtain power scan results. One or more channels are removed from the power scan results. An acquisition process is performed on the channels in the power scan results. Other aspects, embodiments and features are also claimed and described.

### TECHNICAL FIELD

The technology discussed below relates generally to communication systems, and more specifically to systems and methods for efficient public land mobile network (PLMN) searching. Implementation of embodiments of the technology can be used to enable efficient power consumption, minimize missed pages for call subscriptions, and limit impact to other subscriptions supported by a mobile station.

### BACKGROUND

Wireless communication systems have become an important means by which many people worldwide have come to communicate. A wireless communication system may provide communication for a number of wireless communication devices, each of which may be serviced by a base station.

Users of wireless communication devices desire that their devices have many features. For example, a user may expect to power on a wireless communication device and immediately make or receive a phone call. However, wireless communication devices must perform initial acquisition and camp-on procedures before service can be obtained and wireless communications can be established. Those procedures may need to be performed at power-on and whenever a wireless communication device leaves a service area and then returns to a service area. These procedures may require considerable amounts of time before a user can make a phone call.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A method for wireless communication by a wireless communication device is described. A service search procedure is initiated. A list of channels to perform a power scan on is prepared. One or more channels are removed from the list of channels that use a same public land mobile network as a camped on cell. Frequencies of the channels are obtained from system information. A power scan is performed on the channels in the list of channels to obtain power scan results. One or more channels are removed from the power scan results. An acquisition process is performed on the channels in the power scan results.

The one or more channels removed from the list of channels may include the channel that the wireless communication device is camped on and corresponding neighbor cell channels. The wireless communication device may include inter-radio access technology information. The one or more channels removed from the list of channels may include channels that map to frequencies in the inter-radio access technology information. The acquisition process may not be performed on the skipped channels. The acquisition process may include one or more of decoding a frequency correction channel and decoding a synchronization channel.

The wireless communication device may support multiple system identification modules. The service search procedure may be for a primary system identification module. The one or more channels removed from the list of channels may include one of a) channels corresponding to a camped frequency of the secondary system identification module, inter-frequency NCells and inter-radio access technology NCells and b) a channel that the secondary system identification module is camped on and corresponding NCell channels. The second system identification module may include inter-radio access technology information obtained from SI2-qtr/SI2-ter. The one or more channels removed from the list of channels may include channels corresponding to the inter-radio access technology information.

The wireless communication device may include an extended acquisition database that includes a location area identity, a routing area identity and a public land mobile network identification for each channel. The wireless communication device may obtain a public land mobile network identification, a location area identity and a routing area identity for each channel as part of the acquisition process. Channels in the power scan results that match the public land mobile network identification, the location area identity and the routing area identity obtained during the acquisition process may be removed from the power scan results. Removing channels from the list of channels may include one of a) skipping a power scan on the removed channels and b) skipping an acquisition process on the removed channels.

An apparatus for wireless communication is also described. The apparatus includes a processor, memory in electronic communication with the processor and instructions stored in the memory. The instructions are executable by the processor to initiate a service search procedure. The instructions are also executable by the processor to prepare a list of channels to perform a power scan on. The instructions are further executable by the processor to remove one or more channels from the list of channels that use a same public land mobile network as a camped on cell. Frequencies of the channels are obtained from system information. The instructions are also executable by the processor to perform a power scan on the channels in the list of channels to obtain power scan results. The instructions are further executable by the processor to remove one or more channels from the power scan results. The instructions are also executable by the processor to perform an acquisition process on the channels in the power scan results.

A wireless device is described. The wireless device includes means for initiating a service search procedure. The wireless device also includes means for preparing a list of channels to perform a power scan on. The wireless device further includes means for removing one or more channels from the list of channels that use a same public land mobile network as a camped on cell. Frequencies of the channels are obtained from system information. The wireless device also includes means for performing a power scan on the channels in the list of channels to obtain power scan results. The wireless device further includes means for removing one or more channels from the power scan results. The wireless device also includes means for performing an acquisition process on the channels in the power scan results.

A computer-program product for wireless communications is also described. The computer-program product includes a non-transitory computer-readable medium having instructions thereon. The instructions include code for causing a wireless communication device to initiate a service search procedure. The instructions also include code for causing the wireless communication device to prepare a list of channels to perform a power scan on. The instructions further include code for causing the wireless communication device to remove one or more channels from the list of channels that use a same public land mobile network as a camped on cell. Frequencies of the channels are obtained from system information. The instructions also include code for causing the wireless communication device to perform a power scan on the channels in the list of channels to obtain power scan results. The instructions further include code for causing the wireless communication device to remove one or more channels from the power scan results. The instructions also include code for causing the wireless communication device to perform an acquisition process on the channels in the power scan results.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 shows a wireless communication system with multiple wireless devices according to some embodiments;

FIG. 2 is a flow diagram of a method for efficient PLMN search according to some embodiments;

FIG. 3 is a flow diagram of another method for efficient PLMN searching according to some embodiments;

FIG. 4 is a flow diagram of a method for performing an acquisition process according to some embodiments;

FIG. 5 is a block diagram illustrating a 51-frame multiframe according to some embodiments;

FIG. 6 shows example frame and burst formats in GSM according to some embodiments; and

FIG. 7 illustrates certain components that may be included within a wireless communication device according to some embodiments.

### DETAILED DESCRIPTION

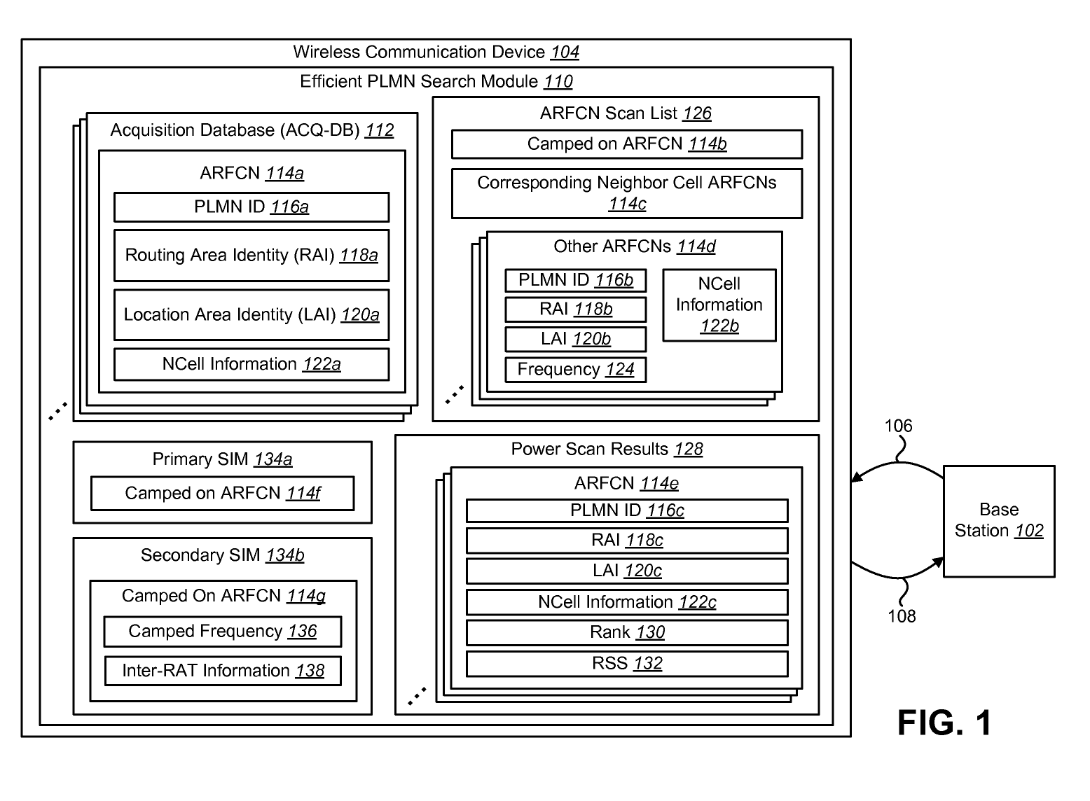

FIG. 1 shows a wireless communication system 100 with multiple wireless devices according to some embodiments. Wireless communication systems 100 are widely deployed to provide various types of communication content such as voice, data and so on. A wireless device may be a base station 102 or a wireless communication device 104. The wireless communication device 104 may be configured for efficient public land mobile network (PLMN) searching. For example, the wireless communication device may be configured to skip some of the absolute radio-frequency channel numbers (ARFCNs) 114 during the PLMN search that are unnecessary. In one configuration, ARFCNs 114 that are known to have the same PLMN information as the ARFCN 114b that the wireless communication device 104 is camped on may be skipped (since the PLMN information for these ARFCNs 114 is redundant). By reducing the number of ARFCNs 114 that are searched during manual PLMN or service search procedures, the search procedure will take less time, improving battery life and user experience.

A base station 102 is a station that communicates with one or more wireless communication devices 104. A base station 102 may also be referred to as, and may include some or all of the functionality of, an access point, a base transceiver station (BTS), a broadcast transmitter, a NodeB, an evolved NodeB, etc. The term “base station” will be used herein. Each base station 102 provides communication coverage for a particular geographic area. A base station 102 may provide communication coverage for one or more wireless communication devices 104. The term “cell” can refer to a base station 102 and/or its coverage area depending on the context in which the term is used.

Communications in a wireless communication system 100 (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink and downlink transmissions are in the same frequency region so that the reciprocity principle allows the estimation of the downlink channel from the uplink channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (WCDMA) systems, time division multiple access (TDMA) systems, frequency division multiple access (FDMA) systems, orthogonal frequency division multiple access (OFDMA) systems, single-carrier frequency division multiple access (SC-FDMA) systems, 3^{rd} Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes WCDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

In 3GPP Long Term Evolution (LTE), a wireless communication device 104 may be referred to as a “user equipment” (UE). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, entertainment device, wearable device, television, computing device, and many other types of devices capable of wireless communication.

A wireless communication device 104 may communicate with zero, one or multiple base stations 102 on the downlink 106a-b and/or uplink 108a-b at any given moment. The downlink 106 (or forward link) refers to the communication link from a base station 102 to a wireless communication device 104, and the uplink 108 (or reverse link) refers to the communication link from a wireless communication device 104 to a base station 102.

The Global System for Mobile Communications (GSM) is a widespread standard in cellular, wireless communication. GSM is relatively efficient for standard voice services. However, high-fidelity audio and data services require higher data throughput rates than that for which GSM is optimized. To increase capacity, the General Packet Radio Service (GPRS) and EDGE (Enhanced Data rates for GSM Evolution) standards have been adopted in GSM systems. In the GSM/EDGE Radio Access Network (GERAN) specification, GPRS and enhanced general packet radio service (EGPRS) provide data services. The standards for GERAN are maintained by the 3GPP (Third Generation Partnership Project). GERAN is a part of GSM. More specifically, GERAN is the radio part of GSM/EDGE together with the network that joins the base stations 102 (the Ater and Abis interfaces) and the base station controllers (A interfaces, etc.). GERAN represents the core of a GSM network. It routes phone calls and packet data from and to the PSTN (Public Switched Telephone Network) and Internet to and from remote terminals. GERAN is also a part of combined UMTS/GSM networks.

GSM employs a combination of Time Division Multiple Access (TDMA) and Frequency Division Multiple Access (FDMA) for the purpose of sharing the spectrum resource. GSM networks typically operate in a number of frequency bands. For example, a GSM network may use the GSM-850 band, the EGSM band (also referred to as the E-GSM-900 band), the DCS (digital cellular service) band (also referred to as DCS-1800), the PCS (personal communications service) band (also referred to as PCS-1900), the P-GSM band, the R-GSM band and the T-GSM band.

The wireless communication device 104 may include an efficient PLMN search module 110. The efficient PLMN search module 110 may allow the wireless communication device 104 to more efficiently search for a PLMN during manual PLMN or service search procedures. Specifically, the efficient PLMN search module 110 may reduce the number of ARFCNs 114 that are searched (i.e., the ARFCNs 114 that the wireless communication device performs a power scan on, a frequency correction channel (FCCH) decode on, a synchronization channel (SCH) decode on and a decoding of the system information type 3 (SI3)/system information type 4 (SI4) of the broadcast control channel (BCCH) on).

The efficient PLMN search module 110 may include an acquisition database (ACQ-DB) 112. A legacy acquisition database (ACQ-DB) 112 may be extended to include additional information for each ARFCN 114 (such as the location area identity (LAI) 120a and routing area identity (RAI) 118a in addition to the PLMN ID 116a and NCell information 122a).

The efficient PLMN search module 110 may also include an ARFCN scan list 126. The ARFCN scan list 126 may be a list of ARFCNs 114 that the wireless communication device 104 will perform a power scan on. The ARFCN scan list 126 may include the camped on ARFCN 114b, the corresponding neighbor cell ARFCNs 114c and other ARFCNs 114d. However, if the wireless communication device 104 is either in Limited or Full Service state, the efficient PLMN search module 110 may remove the camped on ARFCN 114b and the corresponding neighbor cell ARFCNs 114c from the ARFCN scan list 126, as the PLMN information of these ARFCNs 114 will be the same as that of the current serving cell (which is known to the wireless communication device 104). Other ARFCNs 114d may also be removed from the ARFCN scan list 126 based on the PLMN ID 116b, the routing area identity (RAI) 118b, the location area identity (LAI) 120b, the NCell information 122b and/or the frequency 124 of the ARFCNs 114d. Thus, the efficient PLMN search module 110 may reduce the number of ARFCNs 114 that the wireless communication device 104 performs a power scan on.

The efficient PLMN search module 110 may include power scan results 128. The power scan results 128 may include information corresponding to each ARFCN 114c that a power scan was performed on. For example, the power scan results 128 may include the PLMN ID 116c, the routing area identity (RAI) 118c, the location area identity (LAI) 120c, the NCell information 122c, the received signal strength indicator (RSSI) 132 and the rank 130 for each ARFCN 114c that a power scan was performed on. Any ARFCNs 114 that were removed from the ARFCN scan list 126 will also be removed from the power scan results 128, since a power scan is not performed on these ARFCNs 114. The efficient PLMN search module 110 may also remove ARFCNs 114 from the power scan results 128 prior to performing an acquisition (e.g., prior to decoding the FCCH, SCH, and BCCH of each ARFCN 114).

In some configurations, the wireless communication device 104 may support the use of multiple system identification modules (SIMs) 134a-b, referred to as multi-SIM. For example, a primary SIM 134a may be camped on a first ARFCN 114f and a secondary SIM 134b may be camped on a second ARFCN 114g. In this configuration, the primary SIM 134a is performing the manual PLMN or service search procedures and the secondary SIM 134b is camped on either a GSM cell or a non-GSM radio access technology (RAT). If the secondary SIM 134b is not camped on a cell, then no additional considerations are needed for the secondary SIM 134b.

If the secondary SIM 134b is camped on a non-GSM radio access technology (RAT), the wireless communication device 104 can skip the power scan on all the GSM ARFCNs 114 corresponding to the camped frequency 136 of the secondary SIM 134b. Thus, the efficient PLMN search module 110 can remove these ARFCNs 114 from the ARFCN scan list 126. The wireless communication device 104 can also skip performing the power scan on the corresponding inter-frequency NCells and Inter-RAT NCells. Thus, the ARFCNs 114 sharing inter-frequency NCells and/or Inter-RAT NCells with the secondary SIM 134b may also be removed from the ARFCN scan list 126. As discussed above, the FCCH, SCH and BCCH decode will not be performed on ARFCNs 114 that are removed from the ARFCN scan list 126 (since the FCCH, SCH and BCCH decode are only performed on the power scan results 128).

If the secondary SIM 134b is camped on a GSM cell, the wireless communication device 104 can skip the power scan for the GSM ARFCN 114g that the secondary SIM 134b is camped on. The wireless communication device 104 can also skip the power scan on the ARFCNs 114 with NCells that correspond to the NCell of the camped on ARFCN 114g of the secondary SIM 134b. The ARFCN 114 that the secondary SIM 134b is camped on and the ARFCNs 114 corresponding to the NCell that the secondary SIM 134b is camped on may be removed from the ARFCN scan list 126. Thus, the wireless communication device 104 may also skip the FCCH, SCH and BCCH decode of the ARFCN 114g that the secondary SIM 134b is camped on and ARFCNs 114 that correspond to the NCell that the secondary SIM 134b is camped on. If the secondary SIM 134b has inter-RAT information 138 that is obtained from SI2-qtr/SI2-ter, then a power scan of the corresponding GSM ARFCNs 114 may also be skipped.

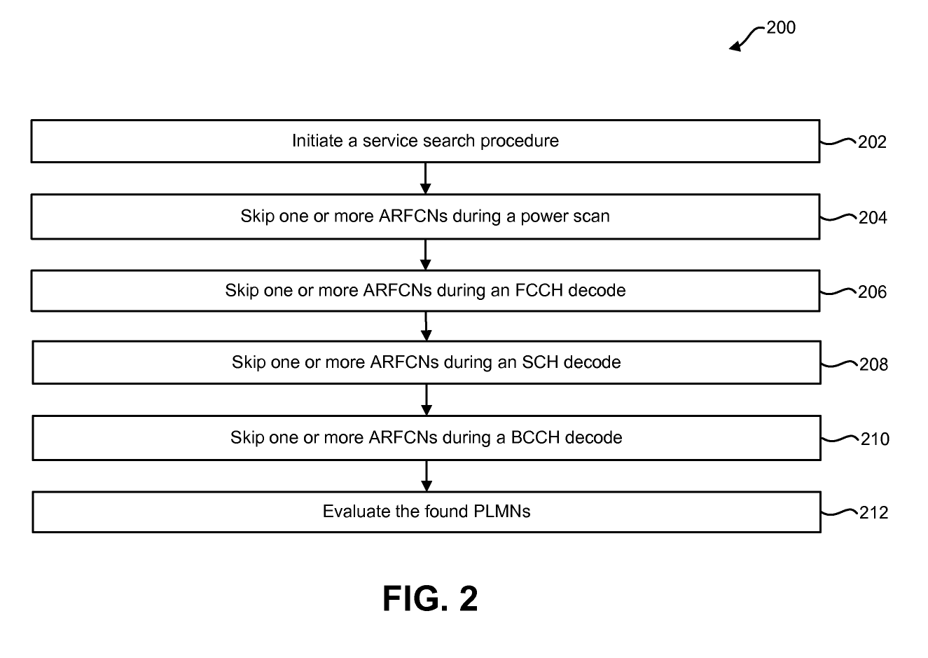

FIG. 2 is a flow diagram of a method 200 for efficient PLMN search according to some embodiments. The method 200 may be performed by a wireless communication device 104. The wireless communication device 104 may include an efficient PLMN search module 110. The wireless communication device 104 may initiate 202 a service search procedure in GSM. The service search procedure may include performing a power scan and then decoding certain information based on the results of the power scan.

The wireless communication device 104 may skip 204 specific ARFCNs 114 during a power scan. For example, the wireless communication device 104 may skip 204 the ARFCN 114b that the wireless communication device 104 is camped on and the corresponding neighbor cell ARFCNs 114c. In other words, the wireless communication device 104 may remove certain ARFCNs 114 from the ARFCN scan list 126 prior to performing a power scan on the ARFCNs 114 in the ARFCN scan list 126. The wireless communication device may remove those ARFCNs 114 from the ARRCN scan list 126 that use the same PLMN as the camped on cell. The ARFCN frequencies may be obtained from system information.

The wireless communication device 104 may skip 206 one or more ARFCNs 114 during an FCCH decode. For example, the wireless communication device 104 may skip 206 those ARFCNs 114 that were skipped during the power scan. The wireless communication device 104 may also skip 208 one or more ARFCNs 114 during an SCH decode. The wireless communication device 104 may further skip 210 one or more ARFCNs 114 during a BCCH decode. For example, the wireless communication device 104 may not decode the SI3/SI4 of the BCCH for ARFCNs 114 that have the same PLMN information as the current serving cell. The wireless communication device 104 may then evaluate 212 the found PLMNs. For example, the wireless communication device 104 may determine whether to switch to a different ARFCN 114 to obtain access to a different PLMN.

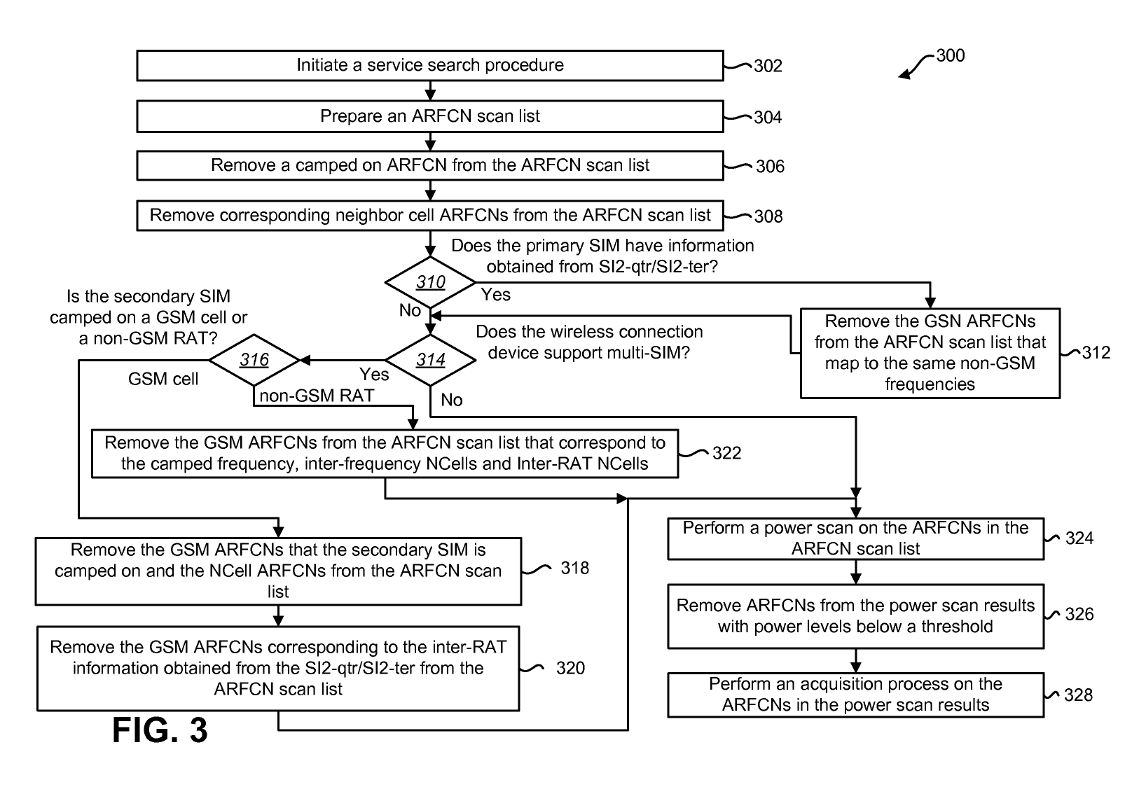

FIG. 3 is a flow diagram of another method 300 for efficient PLMN searching according to some embodiments. The method 300 may be performed by a wireless communication device 104. In one configuration, the wireless communication device 104 may include an efficient PLMN search module 110. The wireless communication device 104 may initiate 302 a service search procedure. The wireless communication device 104 may prepare 304 an ARFCN scan list 126. A wireless communication device 104 may typically perform a power scan on each and every band/mode that the wireless communication device 104 may operate on. Thus, the number of ARFCNs 114 in the ARFCN scan list 126 may be large. Depending on the number of ARFCNs 114 found in the power scan, the entire search process may take a considerable amount of time (approximately 20 to 30 seconds, depending on the field conditions). Skipping some ARFCNs 114 during both the power scan and the corresponding decoding may reduce the amount of time needed to perform a manual PLMN or service search procedure (e.g., reducing the search duration by between 30% and 50% based on the deployment), thereby improving the user experience.

The wireless communication device 104 may remove 306 a camped on ARFCN 114b from the ARFCN scan list 126. In other words, the wireless communication device 104 may skip performing a power scan on the camped on ARFCN 114b, since the PLMN information for the camped on ARFCN 114b is already known. The wireless communication device 104 may also remove 308 the corresponding neighbor cell ARFCNs 114c from the ARFCN scan list 126, as the PLMN information for these neighbor cell ARFCNs 114c is the same as the current serving cell. By removing the camped on ARFCN 114b and the corresponding neighbor cell ARFCNs 114c from the ARFCN scan list 126, the wireless communication device 104 is effectively skipping both a power scan of these ARFCNs 114 and the corresponding FCCH, SCH and BCCH decoding of these ARFCNs 114.

The wireless communication device 104 may determine 310 whether the primary SIM 134a has information that is obtained from the SI2-qtr/SI2-ter. If the primary SIM 134a has information that is obtained from the SI2-qtr/SI2-ter, the wireless communication device 104 may remove 312 the GSM ARFCNs 114 that map to the same non-GSM frequencies from the ARFCN scan list 126. For example, if SI2q broadcasts the UMTS frequency, then the wireless communication device 104 may omit the power scan for all GSM ARFCNs 114 that map to this UMTS frequency. As discussed above, by removing an ARFCN 114 from the ARFCN scan list 126, the wireless communication device 104 is effectively skipping a power scan, FCCH decode, SCH decode and BCCH decode of that ARFCN 114.

After removing the ARFCNs 114 from the ARFCN scan list 126, the wireless communication device 104 may determine 314 whether the wireless communication device 104 supports multi-SIM.

If the primary SIM 134a does not have inter-RAT information, the wireless communication device 104 may determine 314 whether the wireless communication device 104 supports multi-SIM. If the wireless communication device 104 does not support multi-SIM, the wireless communication device 104 may perform 324 a power scan on the ARFCNs 114 in the ARFCN scan list 126.

If the wireless communication device 104 does support multi-SIM, the wireless communication device 104 may determine 316 whether the secondary SIM 134b is camped on a GSM cell or on a non-GSM radio access technology (RAT). If the secondary SIM 134b is camped on a GSM cell, the wireless communication device 104 may remove 318 the GSM ARFCN 114 that the secondary SIM 134b is camped on and the ARFCNs 114 that share NCell information 122b with the GSM ARFCN 114 from the ARFCN scan list 126. The wireless communication device 104 may also remove 320 any GSM ARFCNs 114 corresponding to inter-RAT information 138 obtained from SI2-qtr/SI3-ter from the ARFCN scan list 126. The wireless communication device 104 may then perform 324 a power scan on the ARFCNs 114 in the ARFCN scan list 126.

If the secondary SIM 134b is camped on a non-GSM radio access technology (RAT), the wireless communication device may remove 322 the GSM ARFCNs 114 corresponding to the camped frequency of the secondary SIM 134b, the ARFCNs 114 corresponding to the inter-frequency NCells of the secondary SIM 134b and the ARFCNs 114 corresponding to the inter-RAT NCells of the secondary SIM 134b from the ARFCN scan list 126. The wireless communication device 104 may then perform 324 a power scan on the ARFCNs 114 in the ARFCN scan list 126.

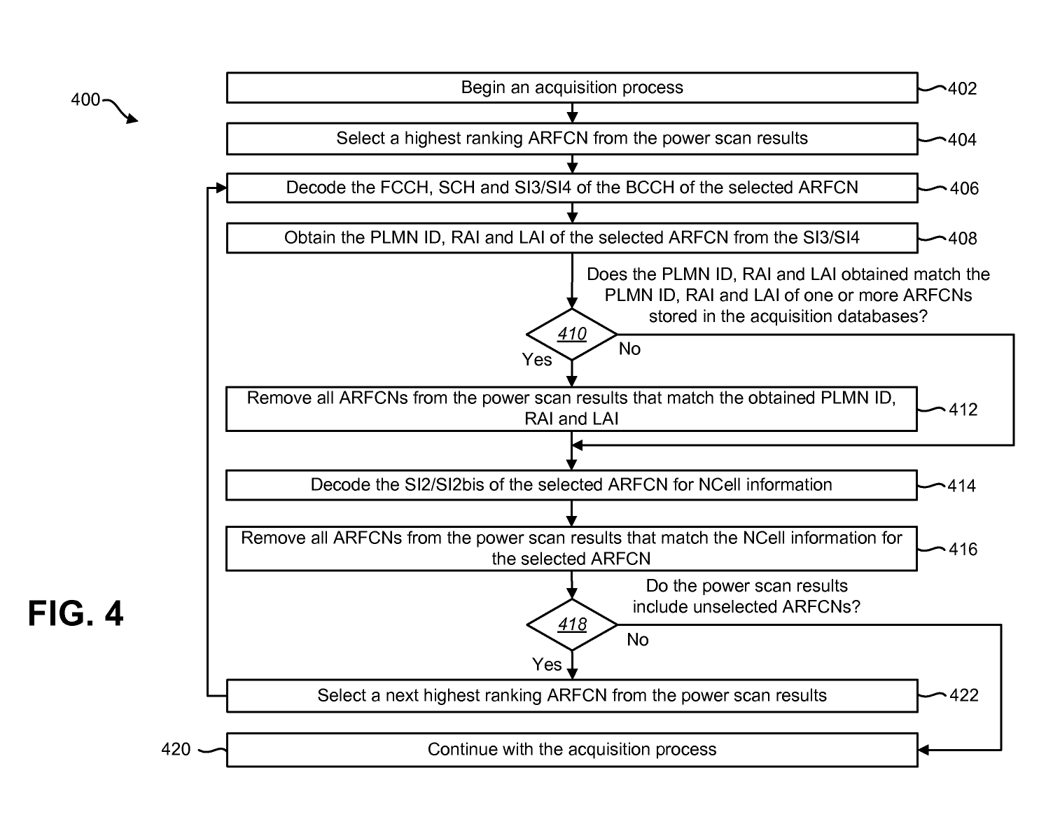

After performing 324 a power scan on the ARFCNs 114 in the ARFCN scan list 126, the wireless communication device 104 may remove 326 ARFCNs 114e from the power scan results 128 with power levels below a threshold. For example, the wireless communication device 104 may remove all ARFCNs 114e with measured received signal strength indicator (RSSI) 132 values that are below a threshold. The wireless communication device 104 may then perform 328 an acquisition process on the ARFCNs 114e in the power scan results 128. The acquisition process may include decoding the FCCH, decoding the SCH, decoding the BCCH and/or decoding SI3/SI4 of the BCCH. The acquisition process is discussed in additional detail below in relation to FIG. 4.

FIG. 4 is a flow diagram of a method 400 for performing an acquisition process according to some embodiments. The method 400 may be performed by a wireless communication device 104. The wireless communication device 104 may be configured with an efficient PLMN search module 110. The wireless communication device 104 may begin 402 an acquisition process. The wireless communication device 104 may select 404 a highest ranking ARFCN 114e from the power scan results 128. The wireless communication device 104 may decode 406 the FCCH, SCH and SI3/SI4 of the BCCH of the selected ARFCN 114e. The wireless communication device 104 may obtain 408 the PLMN ID 116c, the routing area identity (RAI) 118c and the location area identity (LAI) 120c of the selected ARFCN 114e from the SI3/SI4.

The wireless communication device 104 may compare 410 the PLMN ID 116c, the routing area identity (RAI) 118c and the location area identity (LAI) 120c of the selected ARFCN 114e with information stored in the acquisition database (ACQ-DB) 112. For example, the wireless communication device 104 may determine whether the PLMN ID 116c, the routing area identity (RAI) 118c and the location area identity (LAI) 120c obtained match the PLMN ID 116a, routing area identity (RAI) 118a and location area identity (LAI) 120a of one or more ARFCNs 114a stored in the acquisition database (ACQ-DB) 112. If the PLMN ID 116c, routing area identity (RAI) 118c and location area identity (LAI) 120c obtained do not match the PLMN ID 116a, routing area identity (RAI) 118a and location area identity (LAI) 120a of one or more ARFCNs 114a stored in the acquisition database (ACQ-DB) 112, the wireless communication device 104 may decode 414 the SI2/SI2bis of the selected ARFCN 114e for NCell information 122c.

If the PLMN ID 116c, routing area identity (RAI) 118c and location area identity (LAI) 120c obtained matches the PLMN ID 116a, routing area identity (RAI) 118a and location area identity (LAI) 120a of one or more ARFCNs 114a stored in the acquisition database (ACQ-DB) 112, the wireless communication device 104 may remove 412 the ARFCNs 114e from the power scan results 128 that match the obtained PLMN ID 116a, routing area identity (RAI) 118a and/or location area identity (LAI) 120a. The wireless communication device 104 may then decode 414 the SI2/SI2bis of the selected ARFCN 114e for NCell information 122c.

The wireless communication device 104 may remove 416 all ARFCNs 114e from the power scan results 128 that match the NCell information 122e for the selected ARFCN 114e. In other words, the wireless communication device 104 may skip the decoding process for ARFCNs 114 that are removed from the power scan results 128.

The wireless communication device may determine 418 whether the power scan results 128 include unselected ARFCNs 114e. If the power scan results 128 do not include unselected ARFCNs 114e, the wireless communication device 104 may continue 420 with the acquisition process. If the power scan results 128 do include unselected ARFCNs 114e, the wireless communication device 104 may select 422 a next highest ranking ARFCN 114e from the power scan results 128. The wireless communication device 104 may then decode 406 the FCCH, SCH and SI3/SI4 of the BCCH of the selected ARFCN 114e.

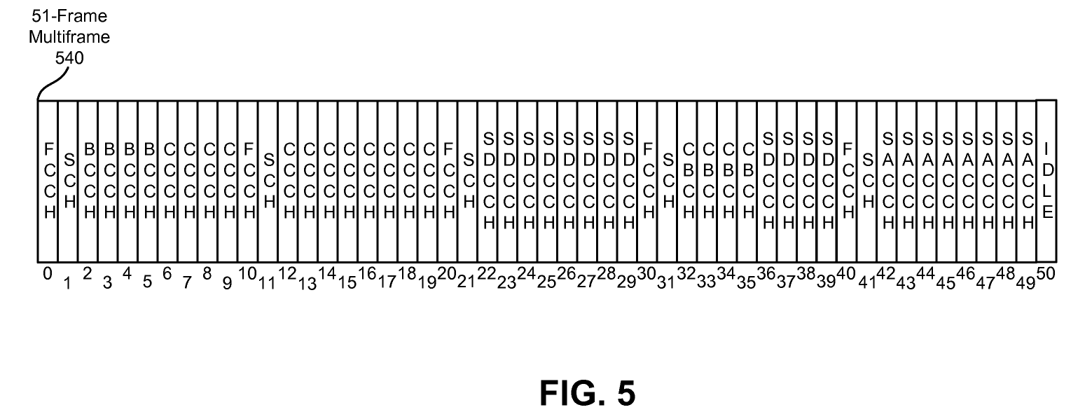

FIG. 5 is a block diagram illustrating a 51-frame multiframe 540 according to some embodiments. Different channels may be mapped to different frames within the 51-frame multiframe 540. For example, the broadcast control channel (BCCH) may be mapped to frames 2 through 5. The mapping of the channels to specific frames may be fixed by an applicable standard.

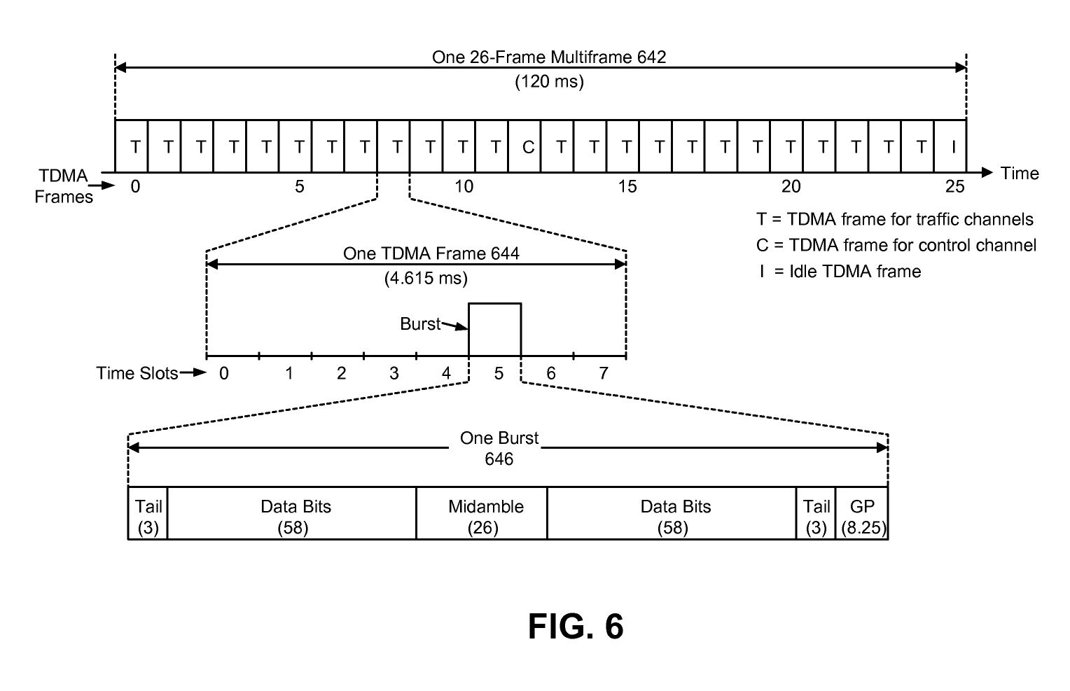

FIG. 6 shows example frame and burst formats in GSM according to some embodiments. The timeline for transmission is divided into multiframes 642. For traffic channels used to transmit user-specific data, each multiframe 642 in this example includes 26 TDMA frames 644, which are labeled as TDMA frames 0 through 25. The traffic channels, in this example, are sent in TDMA frames 0 through 11 and TDMA frames 13 through 24 of each multiframe 642 (other mappings are possible using half-rate channels or Voice services over Adaptive Multi-user channels on One Slot (VAMOS)). A control channel is sent in TDMA frame 12. No data is sent in idle TDMA frame 25, which is used by the wireless communication devices 104 to make measurements of signals transmitted by neighbor base stations 102.

Each time slot within a frame is also referred to as a “burst” 646 in GSM. Each burst 646, in this example, includes two tail fields, two data fields, a training sequence (or midamble) field and a guard period (GP). The number of symbols in each field is shown inside the parentheses. A burst 646 includes symbols for the tail, data, and midamble fields. No symbols are sent in the guard period. TDMA frames of a particular carrier frequency are numbered and formed in groups of 26 or 51 TDMA frames 644 called multiframes 642.

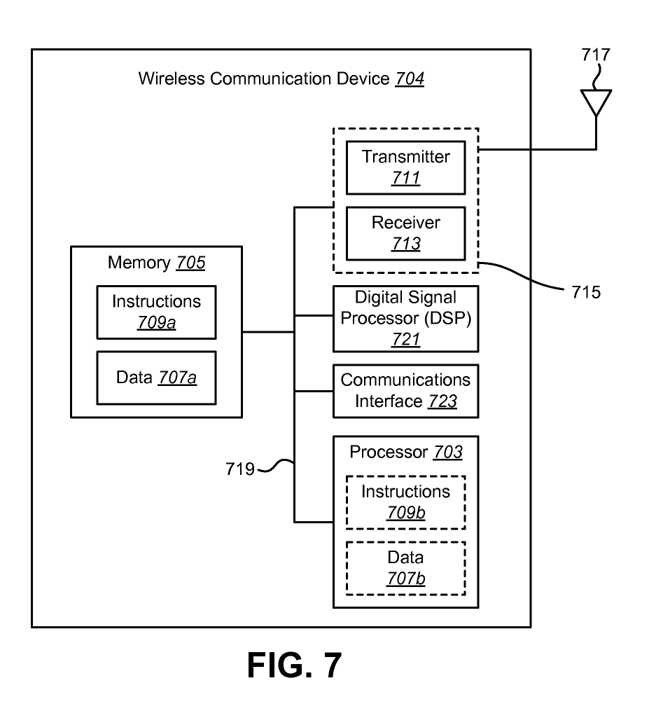

FIG. 7 illustrates certain components that may be included within a wireless communication device 704 according to some embodiments. The wireless communication device 704 of FIG. 7 may be one configuration of the wireless communication device 104 of FIG. 1. The wireless communication device 704 may be an access terminal, a mobile station, a user equipment (UE), etc. The wireless communication device 704 includes a processor 703. The processor 703 may be a general purpose single- or multi-chip microprocessor (e.g., an ARM), a special purpose microprocessor (e.g., a digital signal processor (DSP)), a microcontroller, a programmable gate array, etc. The processor 703 may be referred to as a central processing unit (CPU). Although just a single processor 703 is shown in the wireless communication device 704 of FIG. 7, in an alternative configuration, a combination of processors (e.g., an ARM and DSP) could be used.

The wireless communication device 704 also includes memory 705. The memory 705 may be any electronic component capable of storing electronic information. The memory 705 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 707a and instructions 709a may be stored in the memory 705. The instructions 709a may be executable by the processor 703 to implement the methods disclosed herein. Executing the instructions 709a may involve the use of the data 707a that is stored in the memory 705. When the processor 703 executes the instructions 709, various portions of the instructions 709b may be loaded onto the processor 703, and various pieces of data 707b may be loaded onto the processor 703. In one configuration, the processor 703 may include the optimized camping module 112 discussed above.

The wireless communication device 704 may also include a transmitter 711 and a receiver 713 to allow transmission and reception of signals to and from the wireless communication device 704 via an antenna 717. The transmitter 711 and receiver 713 may be collectively referred to as a transceiver 715. The wireless communication device 704 may also include (not shown) multiple transmitters, multiple antennas, multiple receivers and/or multiple transceivers.

The wireless communication device 704 may include a digital signal processor (DSP) 721. The wireless communication device 704 may also include a communications interface 723. The communications interface 723 may allow a user to interact with the wireless communication device 704.

The various components of the wireless communication device 704 may be coupled together by one or more buses, which may include a power bus, a control signal bus, a status signal bus, a data bus, etc. For the sake of clarity, the various buses are illustrated in FIG. 7 as a bus system 719.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, processing circuitry, hardware circuits, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 2-4, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized. For example, some of the methods described herein may be performed by a processor 703, software and/or firmware.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for wireless communication by a wireless communication device, comprising:
initiating a service search procedure;
preparing a list of channels to perform a power scan on;
removing one or more channels from the list of channels that use a same public land mobile network as a camped on cell, wherein frequencies of the channels are obtained from system information;
performing a power scan on the channels in the list of channels to obtain power scan results;
removing one or more channels from the power scan results; and
performing an acquisition process on the channels in the power scan results.

2. The method of claim 1, wherein the one or more channels removed from the list of channels comprises the channel that the wireless communication device is camped on and corresponding neighbor cell channels.

3. The method of claim 1, wherein the wireless communication device comprises inter-radio access technology information, and wherein the one or more channels removed from the list of channels comprises channels that map to frequencies in the inter-radio access technology information.

4. The method of claim 1, wherein the acquisition process is not performed on the skipped channels.

5. The method of claim 1, wherein the acquisition process comprises one or more of:
decoding a frequency correction channel; and
decoding a synchronization channel.

6. The method of claim 1, wherein the wireless communication device supports multiple system identification modules, wherein the service search procedure is for a primary system identification module, and wherein the one or more channels removed from the list of channels comprises one of a) channels corresponding to a camped frequency of the secondary system identification module, inter-frequency NCells and inter-radio access technology NCells and b) a channel that the secondary system identification module is camped on and corresponding NCell channels.

7. The method of claim 6, wherein the second system identification module comprises inter-radio access technology information obtained from SI2-qtr/SI2-ter, and wherein the one or more channels removed from the list of channels further comprises channels corresponding to the inter-radio access technology information.

8. The method of claim 1, wherein the wireless communication device comprises an extended acquisition database that comprises a location area identity, a routing area identity and a public land mobile network identification for each channel.

9. The method of claim 8, wherein the wireless communication device obtains a public land mobile network identification, a location area identity and a routing area identity for each channel as part of the acquisition process, and wherein channels in the power scan results that match the public land mobile network identification, the location area identity and the routing area identity obtained during the acquisition process are removed from the power scan results.

10. The method of claim 1, wherein removing channels from the list of channels comprises one of a) skipping a power scan on the removed channels and b) skipping an acquisition process on the removed channels.

11. An apparatus for wireless communication, comprising:
a processor;
memory in electronic communication with the processor; and
instructions stored in the memory, the instructions being executable by the processor to:
initiate a service search procedure;
prepare a list of channels to perform a power scan on;
remove one or more channels from the list of channels that use a same public land mobile network as a camped on cell, wherein frequencies of the channels are obtained from system information;
perform a power scan on the channels in the list of channels to obtain power scan results;
remove one or more channels from the power scan results; and
perform an acquisition process on the channels in the power scan results.

12. The apparatus of claim 11, wherein the one or more channels removed from the list of channels comprises the channel that the wireless communication device is camped on and corresponding neighbor cell channels.

13. The apparatus of claim 11, wherein the wireless communication device comprises inter-radio access technology information, and wherein the one or more channels removed from the list of channels comprises channels that map to frequencies in the inter-radio access technology information.

14. The apparatus of claim 11, wherein the acquisition process is not performed on the skipped channels.

15. The apparatus of claim 11, wherein the acquisition process comprises one or more of:
decoding a frequency correction channel; and
decoding a synchronization channel.

16. The apparatus of claim 11, wherein the apparatus supports multiple system identification modules, wherein the service search procedure is for a primary system identification module, and wherein the one or more channels removed from the list of channels comprises one of a) channels corresponding to a camped frequency of the secondary system identification module, inter-frequency NCells and inter-radio access technology NCells and b) a channel that the secondary system identification module is camped on and corresponding NCell channels.

17. The apparatus of claim 16, wherein the second system identification module comprises inter-radio access technology information obtained from SI2-qtr/SI2-ter, and wherein the one or more channels removed from the list of channels further comprises channels corresponding to the inter-radio access technology information.

18. The apparatus of claim 11, wherein the apparatus comprises an extended acquisition database that comprises a location area identity, a routing area identity and a public land mobile network identification for each channel.

19. The apparatus of claim 18, wherein the apparatus obtains a public land mobile network identification, a location area identity and a routing area identity for each channel as part of the acquisition process, and wherein channels in the power scan results that match the public land mobile network identification, the location area identity and the routing area identity obtained during the acquisition process are removed from the power scan results.

20. The apparatus of claim 11, wherein removing channels from the list of channels comprises one of a) skipping a power scan on the removed channels and b) skipping an acquisition process on the removed channels.

21. A wireless device, comprising:
means for initiating a service search procedure;
means for preparing a list of channels to perform a power scan on;
means for removing one or more channels from the list of channels that use a same public land mobile network as a camped on cell, wherein frequencies of the channels are obtained from system information;
means for performing a power scan on the channels in the list of channels to obtain power scan results;
means for removing one or more channels from the power scan results; and
means for performing an acquisition process on the channels in the power scan results.

22. The wireless device of claim 21, wherein the one or more channels removed from the list of channels comprises the channel that the wireless device is camped on and corresponding neighbor cell channels.

23. The wireless device of claim 21, wherein the wireless device comprises inter-radio access technology information, and wherein the one or more channels removed from the list of channels comprises channels that map to frequencies in the inter-radio access technology information.

24. The wireless device of claim 21, wherein the acquisition process is not performed on the skipped channels.

25. The wireless device of claim 21, wherein the acquisition process comprises one or more of:
decoding a frequency correction channel; and
decoding a synchronization channel.

26. A computer-program product for wireless communications, the computer-program product comprising a non-transitory computer-readable medium having instructions thereon, the instructions comprising:
code for causing a wireless communication device to initiate a service search procedure;
code for causing the wireless communication device to prepare a list of channels to perform a power scan on;
code for causing the wireless communication device to remove one or more channels from the list of channels that use a same public land mobile network as a camped on cell, wherein frequencies of the channels are obtained from system information;
code for causing the wireless communication device to perform a power scan on the channels in the list of channels to obtain power scan results;
code for causing the wireless communication device to remove one or more channels from the power scan results; and
code for causing the wireless communication device to perform an acquisition process on the channels in the power scan results.

27. The computer-program product of claim 26, wherein the one or more channels removed from the list of channels comprises the channel that the wireless communication device is camped on and corresponding neighbor cell channels.

28. The computer-program product of claim 26, wherein the wireless communication device comprises inter-radio access technology information, and wherein the one or more channels removed from the list of channels comprises channels that map to frequencies in the inter-radio access technology information.

29. The computer-program product of claim 26, wherein the acquisition process is not performed on the skipped channels.

30. The computer-program product of claim 26, wherein the acquisition process comprises one or more of:
decoding a frequency correction channel; and
decoding a synchronization channel.
